(19) United States
(12) Patent Application Publication
(10) Pub. No.: US 2018/0260808 A1
(43) Pub. Date: Sep. 13, 2018

(54) PROXIMITY-BASED ORDERING

(71) Applicant: Mobile Bytes, LLC., Phoenix, AZ (US)

(72) Inventors: Daniel J. Calderone, Phoenix, AZ (US); Shawn Parent, San Diego, CA (US); Cyril Jordan Statt, Glendale, AZ (US)

(73) Assignee: Mobile Bytes, LLC., Phoenix, AZ (US)

(21) Appl. No.: 15/457,494

(22) Filed: Mar. 13, 2017

(51) Int. Cl. G06Q 20/32; H04W 4/00

(52) U.S. Cl. CPC G06Q 20/3278; H04W 88/02; G06Q 20/3224; H04W 4/008

(57) ABSTRACT

A proximity-based ordering system allows users to initiate an order, which may be fulfilled upon the user's arrival at a merchant location, such as a restaurant. The user may input the order to an application on a mobile device prior to arriving at a merchant. When the user arrives at the merchant, the mobile device may detect a beacon at the merchant location. The merchant may transmit a notification to the user's mobile device that the order is being prepared. Once the order is prepared, the merchant may transmit a notification to the user's mobile device that the order is ready.

### FIELD

The present disclosure relates to mobile technology, and more particularly, to proximity-based ordering with mobile devices.

### BACKGROUND

Merchants, such as restaurants which take orders at a counter, typically use a person operating a point-of-sale register. Customers must wait in line in order to place their order. Similarly, for sit down restaurants, customers are not able to place their order until after they have been seated and a waiter takes their order. It can be time consuming and frustrating for consumers to stand in line for long periods of time to place an order, then wait again for their food to be prepared after making it to the front of the line and placing an order. Although some restaurants allow customers to call ahead or place an order online which is designated for pickup at a specified time, the customer may not know exactly when the customer will arrive at the restaurant, resulting in food orders which may be cold or not yet prepared.

### SUMMARY

Systems and methods are disclosed for proximity-based ordering. The method may include broadcasting, using a beacon, a beacon identification; receiving a notification that a mobile device has detected the beacon; receiving an order from the mobile device; transmitting, in response to the receiving the notification, an order confirmation to the mobile device; printing an order ticket; and transmitting, in response to the order being ready, an order ready notification to the mobile device.

In various embodiments, the method may comprise determining, in response to the receiving the notification, that the mobile device is within a merchant premises. The beacon may comprise at least one of a Bluetooth low energy beacon or a near field communication beacon. The order may be received prior to the receiving the notification. In response to the receiving the notification, a welcome notification may be transmitted to the mobile device. The system may transmit an offer to the mobile device. The system may receive, from the mobile device, payment information for the order.

The foregoing features and elements may be combined in various combinations without exclusivity, unless expressly indicated otherwise. These features and elements as well as the operation thereof will become more apparent in light of the following description and the accompanying drawings. It should be understood, however, the following description and drawings are intended to be exemplary in nature and non-limiting.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the drawing figures, wherein like numerals denote like elements.

FIG. 1 illustrates a schematic view of a system for proximity-based ordering in accordance with various embodiments;

FIG. 2 illustrates a screenshot of a welcome screen for a proximity-based application in accordance with various embodiments;

FIG. 3 illustrates a screenshot of an ordering page in accordance with various embodiments;

FIG. 4 illustrates a screenshot of an arrival push notification in accordance with various embodiments;

FIG. 5 illustrates a screen shot of an order ready notification in accordance with various embodiments; and

FIG. 6 illustrates a flowchart of a process for proximity-based ordering in accordance with various embodiments.

### DETAILED DESCRIPTION

The detailed description of various embodiments herein makes reference to the accompanying drawings, which show various embodiments by way of illustration. While these various embodiments are described in sufficient detail to enable those skilled in the art to practice the inventions, it should be understood that other embodiments may be realized and that changes may be made without departing from the spirit and scope of the inventions. Thus, the detailed description herein is presented for purposes of illustration only and not of limitation. For example, the steps recited in any of the method or process descriptions may be executed in any order and are not necessarily limited to the order presented.

Furthermore, any reference to singular includes plural embodiments, and any reference to more than one component or step may include a singular embodiment or step. Also, any reference to attached, fixed, connected or the like may include permanent, removable, temporary, partial, full and/or any other possible attachment option.

Systems and methods for proximity-based ordering are disclosed. A user may input an order into a mobile device prior to entering a merchant location. A user may enter the merchant location, such as a restaurant. A merchant system may detect the mobile device of the user, or the user's mobile device may detect the merchant system. For example, a Bluetooth Low Energy (“BLE”) device may broadcast a signal including a beacon identification, and the mobile device may detect the signal. The mobile device may transmit the beacon identification to an application server, and the application server may transmit a notification to the merchant system that the user's mobile device is within range of the merchant system. The mobile device may transmit the order to the merchant system in response to being within range of the merchant system. If the user has not yet entered an order into the mobile device, the merchant system may communicate with the mobile device and allow the user to place an order and pay from the mobile device, without waiting in line for a cashier. Thus, the merchant may begin preparing the user's order as soon as the user arrives at the merchant.

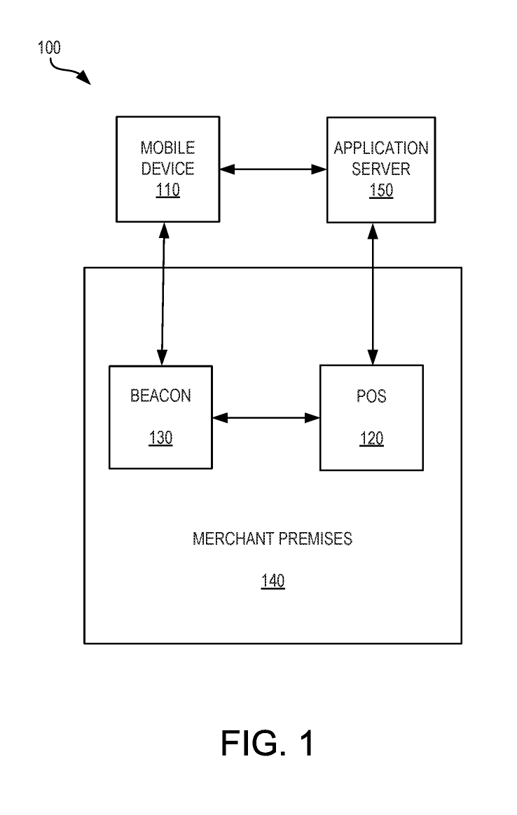

Referring to FIG. 1, a system 100 for proximity-based ordering is illustrated according to various embodiments. The system 100 may comprise a mobile device 110. The mobile device 110 may be operated by a user. The mobile device 110 may be any device capable of communicating over a network, such as a mobile phone. The mobile device 110 may include a proximity-based ordering application stored in a memory of the mobile device 110.

The system 100 may comprise a merchant point-of-sale (“POS”) 120. The POS 120 may be capable of receiving orders and payments. The POS 120 may comprise a computer, server, printer, mobile device, or any other device capable of communicating with, and receiving orders from the mobile device 110. The system may comprise a beacon 130. The beacon 130 may broadcast a signal which may be detected by the mobile device 110 when the mobile device 110 is within range of the beacon 110. The signal may comprise an identification code which uniquely identifies the beacon 110. In various embodiments, the beacon 130 may comprise a BLE beacon, a near field communication beacon, or an optical scanner which may scan indicia on the mobile device 110. In various embodiments, the beacon 130 may be integrated with the POS 120. The POS 120 and the beacon 130 may be located in a merchant premises 140. The merchant premises 140 may be the physical location of a “brick-and-mortar” store. In various embodiments, the beacon 130 may be detected by mobile phones of users who are nearby, but outside of the merchant premises 140, which may enable the POS 120 to transmit offers or advertisements to nearby users.

The system may comprise an application server 150. In various embodiments, the application server 150 may be a portion of a cloud computing system. In response to detecting the signal from the beacon 130, the mobile device 110 may transmit the beacon ID to the application server 150. The application server 150 may correlate the beacon ID with the beacon 130 and the merchant premises 140. The application server 150 may facilitate communications between the mobile device 110 and the POS 120. The various components may communicate over a network, such as a cellular network and/or the Internet.

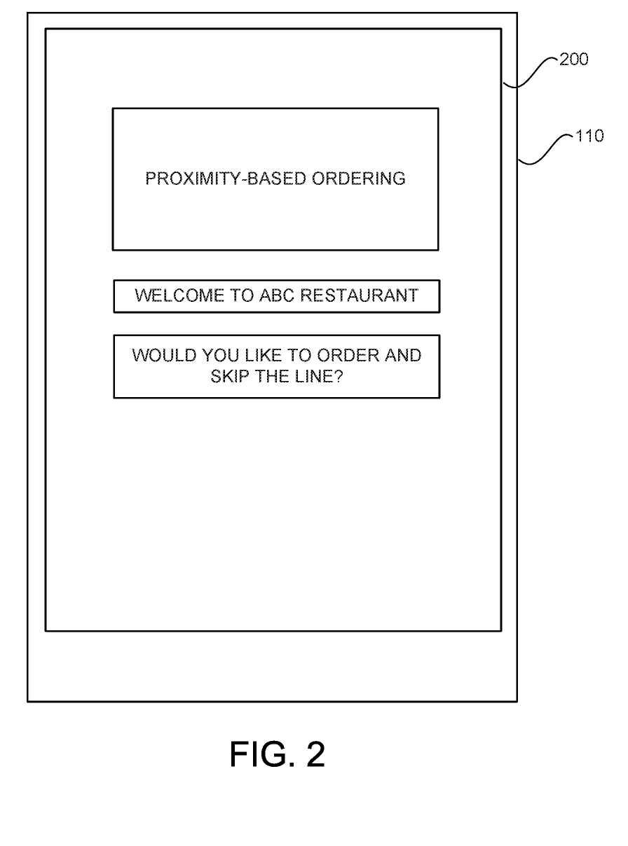

Referring to FIGS. 2-5, a series of example screenshots of a mobile device experience for proximity-based ordering is illustrated according to various embodiments. Referring to FIG. 2, a welcome screen 200 for a proximity-based ordering application is illustrated on the mobile device 110 according to various embodiments. A user may open the application prior to arriving at a merchant location. The application may provide several options to the user, such as to place an order and skip the line, to select or search for a merchant, to select from previous orders, or to view nearby merchants on a map.

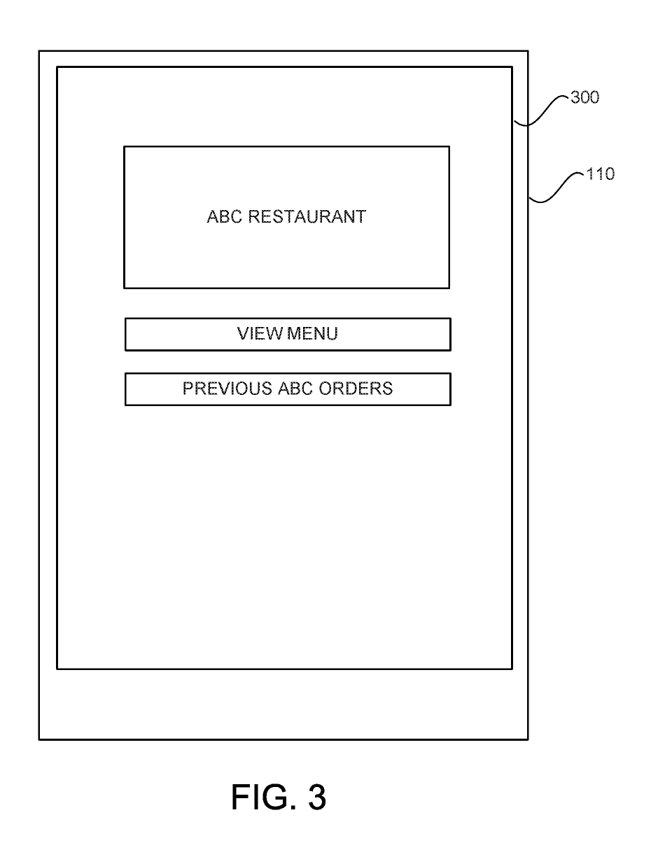

Referring to FIG. 3, a screenshot 300 of an ordering page for a merchant is illustrated according to various embodiments. The user may have selected a particular merchant using the welcome screen shown in FIG. 2. The application may provide the user with the option to view a menu for the merchant or to select from the user's previous orders from the merchant. The user may input an order for one or more items to the application, and the mobile device may store the order. In various embodiments, the mobile device may transmit the order to the merchant. In various embodiments, the user may have the option to instruct the merchant to prepare the order at a specified time, to prepare the order immediately, or to prepare the order upon the user's arrival at the merchant. The mobile application may store payment information for the user, such as a transaction account number, expiration date, billing address, etc. In various embodiments, the mobile application may access a mobile wallet on the mobile device 110 to pay for the order. The mobile device 110 may transmit the payment information to the merchant along with the order.

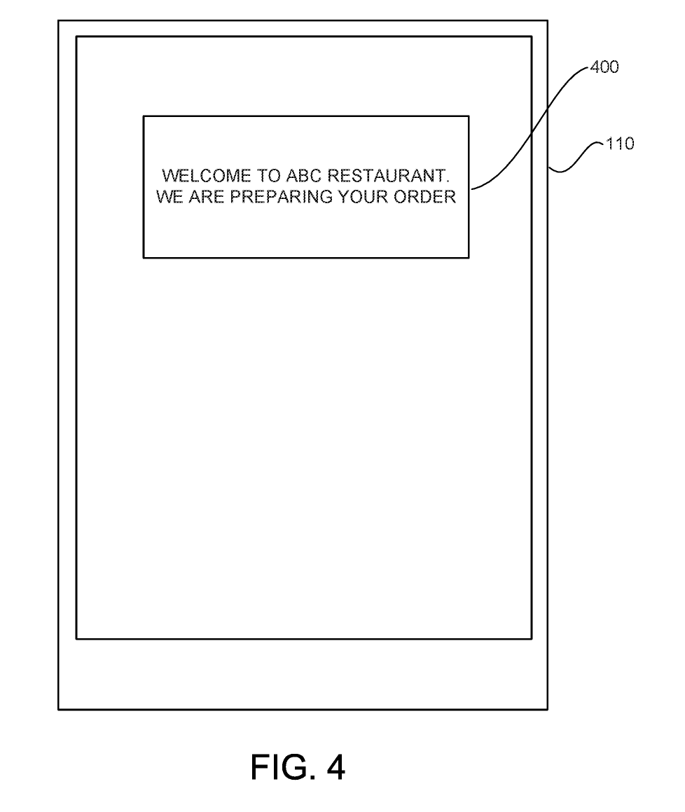

Referring to FIG. 4, an arrival push notification 400 is illustrated according to various embodiments. In various embodiments, the push notification 400 may be sent through an application on the mobile device 110, sent as an SMS notification, or sent via any other suitable method of providing a notification to the mobile device 110. The beacon at the merchant location may be detected by the mobile device 110, indicating that the mobile device 110 is within a specified proximity of the beacon. For example, the mobile device 110 may determine that the mobile device 110 is within 50 feet of the beacon. The mobile device 110 may transmit the beacon ID to a web application server, and the web application server may notify the merchant POS that the mobile device has detected the beacon. This may indicate to the merchant that the user is on the merchant premises. If the user has selected for the order to be prepared upon the user's arrival, the push notification may indicate that the order is acknowledged and is being prepared. For example, a message may state, “Thank you for placing your order. We'll notify you when we've prepared it, just the way you like.” If the user previously selected for the order to be prepared immediately or at a specified time, the push notification may notify the consumer if the order is ready, or approximately when the order will be ready.

In various embodiments, the user may not have previously entered an order to the application. In such case, the push notification may be a welcome notification and may provide the user with the option to open the application and enter an order to the mobile device 110, such that the user does not have to wait in line to order.

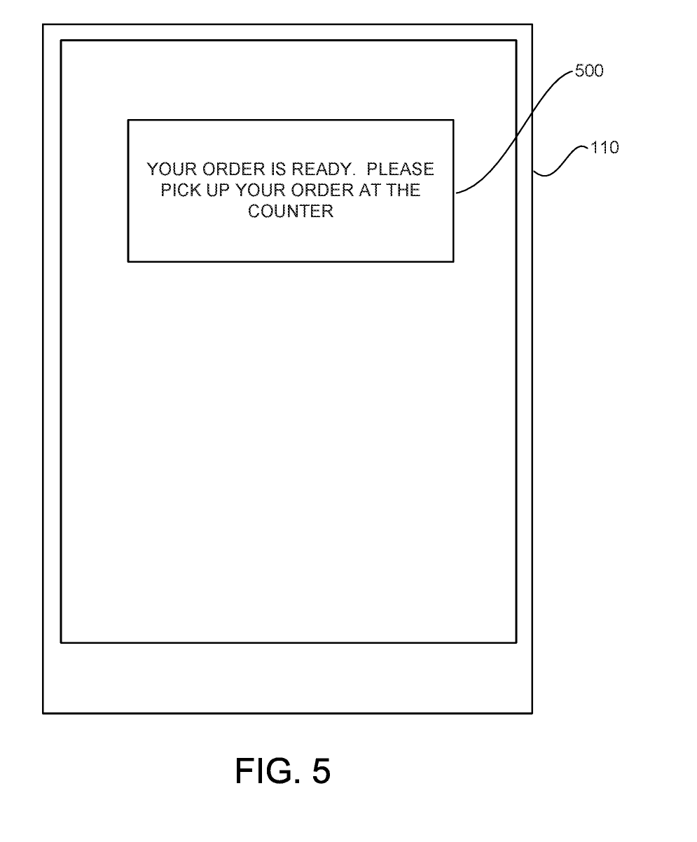

Referring to FIG. 5, an order ready push notification 500 is illustrated according to various embodiments. The merchant POS may transmit the push notification 500 to the user's mobile device 110 to notify the user that the order is ready. The user may then walk to the counter to pick up the order. In various embodiments, the user may indicate where in the merchant premises the user is located, and a merchant employee may bring the order to the user. For example, each table in the merchant location may comprise a beacon, and the beacon may be detected by the mobile device 110 and notify the merchant where the user is located. In various embodiments, the user may manually input a location to the application on the mobile device 110, such as by typing in a table number, or the user may scan an image or code, such as a QR code, with the mobile device 110 which indicates that the user is in a particular location in the merchant premises.

In various embodiments, the application may provide a loyalty incentive program for the user. The application may store past orders and associated loyalty points. In various embodiments, the user may scan a QR code or other indicia on a paper receipt, and the application may store the receipt for loyalty purposes.

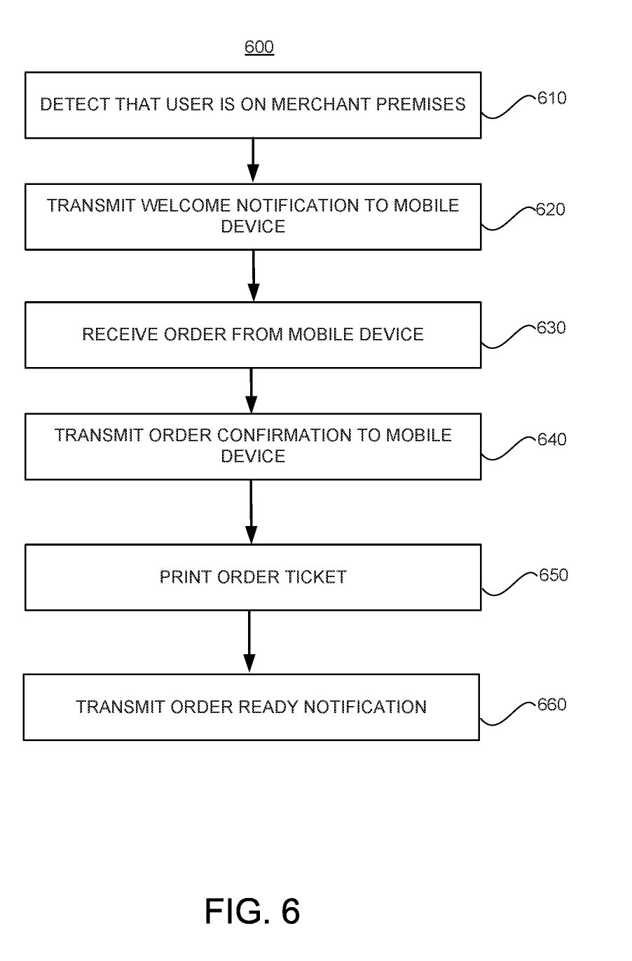

Referring to FIG. 6, a flowchart 600 of a process for proximity-based ordering is illustrated according to various embodiments. A merchant system may detect that a user is on the merchant premises (step 610). The system may use a beacon to broadcast a signal including a beacon ID which may be detected by a mobile device of the user. In various embodiments, the beacon may be at least one of a BLE beacon, a NFC beacon, an optical scanner, or any other suitable type of beacon capable of being detected by a mobile device. The range may be any suitable range. For example, a BLE beacon may be detected by the mobile device if the mobile device is within fifty feet of the beacon. A NFC beacon may be detected by the mobile device if the mobile device is within one foot of the beacon. The mobile device may transmit the beacon ID to an application server, and the application server may transmit a notification to a merchant POS that the mobile device is within range.

The merchant system may transmit a welcome notification to the mobile device (step 620). The welcome notification may be a push notification sent via a mobile application or via text message. The welcome notification may inform the user that the user may enter an order on the user's mobile device and avoid waiting in line or paying at the POS. In various embodiments, the user may input an order to the application prior to entering the merchant premises, and the merchant system may forego transmitting the welcome notification.

The mobile device may transmit an order to the merchant system (step 630). In various embodiments, the order may have been previously transmitted from the mobile device to the merchant system, and in response to detecting that the mobile device is within range, the merchant system may begin preparing the order. In various embodiments, the order may have been previously stored on the mobile device, and in response to the merchant system detecting that the mobile device is within range, the mobile device transmits the order to the merchant system.

The merchant system may transmit an order confirmation to the mobile device (step 640). The order confirmation may notify the consumer that the order has been received and is being prepared. The order confirmation may provide an estimated time that the order will be prepared. In various embodiments, in response to receiving the order notification, the user may be presented the option to enter a table location in order for the merchant to bring the order to the table. For example, after the user sits down at a table, the user may input a table number to the application or hold the mobile device near a NFC beacon. The mobile device or the NFC beacon may then transmit the table location to the merchant POS.

The merchant system may print an order ticket (step 650). The order ticket may be printed in response to detecting that the mobile device is in range. The order ticket may display the items in the user's order. In various embodiments, the order ticket may be printed by displaying the order on a screen of a merchant device, or by printing a paper ticket. Printing the order ticket may place the order ticket in a queue and allow merchant employees to prepare the order.

The merchant system may transmit an order ready notification to the mobile device (step 660). The order ready notification may notify the user that the order is ready for the user to pick up. In various embodiments, the order ready notification may indicate where the order may be picked up, or if the order will be delivered to the user's table.

Any communication, transmission and/or channel discussed herein may include any system or method for delivering content (e.g. data, information, metadata, etc.), and/or the content itself. The content may be presented in any form or medium, and in various embodiments, the content may be delivered electronically and/or capable of being presented electronically. For example, a channel may comprise a website or device (e.g., Facebook, YOUTUBE®, APPLE®TV®, PANDORA®, XBOX®, SONY® PLAYSTATION®), a uniform resource locator (“URL”), a document (e.g., a MICROSOFT® Word® document, a MICROSOFT® Excel® document, an ADOBE® .pdf document, etc.), an “ebook,” an “emagazine,” an application or microapplication (as described herein), an SMS or other type of text message, an email, Facebook, twitter, MMS and/or other type of communication technology. In various embodiments, a channel may be hosted or provided by a data partner. In various embodiments, the distribution channel may comprise at least one of a merchant website, a social media website, affiliate or partner websites, an external vendor, a mobile device communication, social media network and/or location based service. Distribution channels may include at least one of a merchant website, a social media site, affiliate or partner websites, an external vendor, and a mobile device communication. Examples of social media sites include FACEBOOK®, FOURSQUARE®, TWITTER®, MYSPACE®, LINKEDIN®, and the like. Examples of affiliate or partner websites include AMERICAN EXPRESS®, GROUPON®, LIVINGSOCIAL®, and the like. Moreover, examples of mobile device communications include texting, email, and mobile applications for smartphones.

In various embodiments, the methods described herein are implemented using the various particular machines described herein. The methods described herein may be implemented using the below particular machines, and those hereinafter developed, in any suitable combination, as would be appreciated immediately by one skilled in the art. Further, as is unambiguous from this disclosure, the methods described herein may result in various transformations of certain articles.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; merchant data; financial institution data; and/or like data useful in the operation of the system. As those skilled in the art will appreciate, user computer may include an operating system (e.g., WINDOWS®, OS2, UNIX®, LINUX®, SOLARIS®, MacOS, etc.) as well as various conventional support software and drivers typically associated with computers.

The present system or any part(s) or function(s) thereof may be implemented using hardware, software or a combination thereof and may be implemented in one or more computer systems or other processing systems. However, the manipulations performed by embodiments were often referred to in terms, such as matching or selecting, which are commonly associated with mental operations performed by a human operator. No such capability of a human operator is necessary, or desirable in most cases, in any of the operations described herein. Rather, the operations may be machine operations. Useful machines for performing the various embodiments include general purpose digital computers or similar devices.

In fact, in various embodiments, the embodiments are directed toward one or more computer systems capable of carrying out the functionality described herein. The computer system includes one or more processors, such as processor. The processor is connected to a communication infrastructure (e.g., a communications bus, cross-over bar, or network). Various software embodiments are described in terms of this exemplary computer system. After reading this description, it will become apparent to a person skilled in the relevant art(s) how to implement various embodiments using other computer systems and/or architectures. Computer system can include a display interface that forwards graphics, text, and other data from the communication infrastructure (or from a frame buffer not shown) for display on a display unit.

Computer system also includes a main memory, such as for example random access memory (RAM), and may also include a secondary memory. The secondary memory may include, for example, a hard disk drive and/or a removable storage drive, representing a floppy disk drive, a magnetic tape drive, an optical disk drive, etc. The removable storage drive reads from and/or writes to a removable storage unit in a well-known manner. Removable storage unit represents a floppy disk, magnetic tape, optical disk, etc. which is read by and written to by removable storage drive. As will be appreciated, the removable storage unit includes a computer usable storage medium having stored therein computer software and/or data.

In various embodiments, software may be stored in a computer program product and loaded into computer system using removable storage drive, hard disk drive or communications interface. The control logic (software), when executed by the processor, causes the processor to perform the functions of various embodiments as described herein. In various embodiments, hardware components such as application specific integrated circuits (ASICs). Implementation of the hardware state machine so as to perform the functions described herein will be apparent to persons skilled in the relevant art(s).

In various embodiments, components, modules, and/or engines of system 100 may be implemented as micro-applications or micro-apps. Micro-apps are typically deployed in the context of a mobile operating system, including for example, a WINDOWS® mobile operating system, an ANDROID® Operating System, APPLE® IOS®, a BLACKBERRY® operating system and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system which monitors various hardware components and then communicates a detected input from the hardware to the micro-app.

As used herein, the term “network” includes any cloud, cloud computing system or electronic communications system or method which incorporates hardware and/or software components. Communication among the parties may be accomplished through any suitable communication channels, such as, for example, a telephone network, an extranet, an intranet, Internet, point of interaction device (point of sale device, personal digital assistant (e.g., IPHONE®, BLACKBERRY®), cellular phone, kiosk, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although the system is frequently described herein as being implemented with TCP/IP communications protocols, the system may also be implemented using IPX, APPLE®talk, IP-6, NetBIOS®, OSI, any tunneling protocol (e.g. IPsec, SSH), or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, Dilip Naik, Internet Standards and Protocols (1998); JAVA® 2 Complete, various authors, (Sybex 1999); Deborah Ray and Eric Ray, Mastering HTML 4.0 (1997); and Loshin, TCP/IP Clearly Explained (1997) and David Gourley and Brian Totty, HTTP, The Definitive Guide (2002), the contents of which are hereby incorporated by reference.

As used herein, “transmit” may include sending electronic data from one system component to another over a network connection. Additionally, as used herein, “data” may include encompassing information such as commands, queries, files, data for storage, and the like in digital or any other form.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In Re Nuijten to fall outside the scope of patentable subject matter under 35 U.S.C. § 101.

In the detailed description herein, references to “one embodiment,” “an embodiment,” “various embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Benefits, other advantages, and solutions to problems have been described herein with regard to specific embodiments. Furthermore, the connecting lines shown in the various figures contained herein are intended to represent various functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the inventions. The scope of the inventions is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

1. A method for proximity-based ordering comprising:
broadcasting, by a computer-based system and using a beacon, a beacon identification;
receiving, by the computer-based system, a notification that a mobile device has detected the beacon;
receiving, by the computer-based system, an order from the mobile device;
transmitting, by the computer-based system and in response to the receiving the notification, an order confirmation to the mobile device;
printing, by the computer-based system, an order ticket; and
transmitting, by the computer-based system an in response to the order being ready, an order ready notification to the mobile device.

2. The method of claim 1, further comprising determining, by the computer-based system and in response to the receiving the notification, that the mobile device is within a merchant premises.

3. The method of claim 1, wherein the beacon comprises at least one of a Bluetooth low energy beacon or a near field communication beacon.

4. The method of claim 1, wherein the order is received prior to the receiving the notification.

5. The method of claim 1, further comprising transmitting, by the computer-based system and in response to the receiving the notification, a welcome notification to the mobile device.

6. The method of claim 1, further comprising transmitting, by the computer-based system, an offer to the mobile device.

7. The method of claim 1, further comprising receiving, by the computer-based system and from the mobile device, payment information for the order.

8. An article of manufacture including a non-transitory, tangible computer readable storage medium having instructions stored thereon that, in response to execution by a computer-based system, cause the computer-based system to perform operations comprising:
broadcasting, by the computer-based system and using a beacon, a beacon identification;
receiving, by the computer-based system, a notification that a mobile device has detected the beacon;
receiving, by the computer-based system, an order from the mobile device;
transmitting, by the computer-based system and in response to the detecting, an order confirmation to the mobile device;
printing, by the computer-based system, an order ticket; and
transmitting, by the computer-based system an in response to the order being ready, an order ready notification to the mobile device.

9. The article of manufacture of claim 8, the operations further comprising determining, by the computer-based system and in response to the receiving the notification, that the mobile device is within a merchant premises.

10. The article of manufacture of claim 8, wherein the beacon comprises at least one of a Bluetooth low energy beacon or a near field communication beacon.

11. The article of manufacture of claim 8, wherein the order is received prior to the receiving the notification.

12. The article of manufacture of claim 8, the operations further comprising transmitting, by the computer-based system and in response to the receiving the notification, a welcome notification to the mobile device.

13. The article of manufacture of claim 8, the operations further comprising transmitting, by the computer-based system, an offer to the mobile device.

14. The article of manufacture of claim 8, the operations further comprising receiving, by the computer-based system and from the mobile device, payment information for the order.

15. A system comprising:
a processor,
a tangible, non-transitory memory configured to communicate with the processor,
the tangible, non-transitory memory having instructions stored thereon that, in response to execution by the processor, cause the processor to perform operations comprising:
broadcasting, by the processor and using a beacon, a beacon identification;
receiving, by the processor, a notification that a mobile device has detected the beacon;
receiving, by the computer-based system, an order from the mobile device;
transmitting, by the computer-based system and in response to the detecting, an order confirmation to the mobile device;
printing, by the computer-based system, an order ticket; and
transmitting, by the computer-based system an in response to the order being ready, an order ready notification to the mobile device.

16. The system of claim 15, the operations further comprising determining, by the computer-based system and in response to the receiving the notification, that the mobile device is within a merchant premises.

17. The system of claim 15, wherein the beacon comprises at least one of a Bluetooth low energy beacon or a near field communication beacon.

18. The system of claim 15, wherein the order is received prior to the receiving the notification.

19. The system of claim 15, the operations further comprising transmitting, by the computer-based system and in response to the receiving the notification, a welcome notification to the mobile device.

20. The system of claim 15, the operations further comprising transmitting, by the computer-based system, an offer to the mobile device.
